(19) United States
(12) Patent Application Publication
(10) Pub. No.: US 2002/0039890 A1
(43) Pub. Date: Apr. 4, 2002

(54) Mobile telephone body

(75) Inventor: Jai Chul Kim, Anyang-si (KR)

Correspondence Address: FLESHNER & KIM, LLP, P.O. Box 221200, Chantilly, VA, 20153-1200, US

(73) Assignee: LG Electronics Inc.

(21) Appl. No.: 09/920,827

(22) Filed: Aug. 3, 2001

(30) Foreign Application Priority Data
Aug. 8, 2000 (KR) 22530/2000

(51) Int. Cl. H04B 1/38

(52) U.S. Cl. 455/90; 455/575; 455/348

(57) ABSTRACT

The invention relates to a mobile telephone wherein a manner of exposing a button portion thereof can be variably changed. The mobile telephone of the invention includes a telephone body provided with a button portion, and interchangeably button covers detachably fixable to the telephone body so that a mechanism for protecting or covering and exposing the button portion can be selectively changed into a bar type cover, a flip type cover or a sliding lid type cover. The interchangeable button cover may include a bar unit including a frame removably mounted on the telephone body in a such way that the frame covers the button portion and keypads provided on one side of the frame and interlocks with the telephone key buttons of the button portion. The interchangeable button cover may also include a flip unit including a frame attached to the telephone body and a flip type cover hingedly connected to the frame for exposing the button portion by pivoting the flip type cover into an open position. Alternatively, the interchangeable button cover may include a sliding unit including a frame detachably attached to the telephone body and a sliding lid type cover connected to the frame in a manner that allows the sliding unit to slide for exposing the button portion by a sliding action. Accordingly, the manner of exposing the button portion can be changed in accordance with the user's preference, and the user does not easily get bored with the mobile telephone.

### BACKGROUND OF THE INVENTION

1. Field of the Invention

The present invention relates to mobile telephones.

2. Background of the Related Art

Generally, a mobile telephone is a mobile communication device capable of conducting voice communications through a wireless transmission via a relay station. The types of telephone cases housing the telephone circuitry can be mainly classified by the type of cover over the bottom portion of the telephone. The bottom covers include a bar type cover, a flip type cover and a sliding lid type cover based on the means provided for covering and exposing the buttons for operating the telephone.

A bar type cover telephone is shown in FIG. 1, and is constructed such that a button portion 12 of a telephone body 10 is permanently exposed without an additional flip or lid to cover the bottom portion when the telephone is not in use. The flip type cover is constructed such that the button portion 12 of the telephone body can be selectively covered or exposed for use by opening and closing of a flip cover 14 pivotally attached to the telephone body 10, as shown in FIG. 2. The sliding lid type cover 16 is shown in FIG. 3 and is constructed such that the button portion 12 can be selectively covered or exposed for use by opening and closing a sliding lid type cover 16 attached to the telephone body 10 in a manner that allows the sliding lid type cover 16 to slide.

The bar type cover 12 provides a mobile telephone which can be conveniently used without an additional step by the user for exposing the button portion 12. The flip and sliding lid type covers 14 and 16, respectively, have the advantage that an accidental operation of the mobile telephone when it is not in use can be prevented by covering the button portion 12 with the flip type cover 14 or the sliding lid type cover 16. Therefore, the mobile telephones in accordance with the related art require a user to select the type of mobile telephone according to his/her preference at the time of purchases with no way to alter the type at a later time. Thus, the related art mobile telephone has a problem that it is impossible to change the manner of covering and exposing the button portion, and the user is unable to take advantage of the characteristics of the different types of mobile telephones in a single unit. An additional problem with the related art mobile telephone is that the user quickly becomes bored with the type of his/her mobile telephone after a while.

### SUMMARY OF THE INVENTION

An object of the invention is to solve at least the above problems and/or disadvantages and to provide at least the advantages described hereinafter.

In order to solve at least the above-mentioned problems in whole or in part, an object of the invention is to provide a mobile telephone wherein it is possible to change the manner of covering and exposing the button portion thereof so that a user can take advantage of the characteristics of the respective types of mobile telephone types.

Another object of the invention is to provide an alternative mobile telephone body wherein the user does not also easily get bored of continuously using the same type of mobile telephone.

Another object of the invention is to provide a mobile telephone which includes a telephone body provided with a button portion and an interchangeable button cover detachably coupled to the telephone body so that a covering structure for covering and exposing the button portion can be selectively changed into a bar type cover, a flip type cover or a sliding lid type cover.

Another object of the invention is to provide a mobile telephone in which a manner of exposing a button portion can be selectively changed.

Another object of the invention is to provide an interchangeable button cover which may include a bar unit having a frame mounted on the telephone body so as to enclose the button portion and keypads provided on one side of the frame and interlocked with key buttons of the button portion. The interchangeable button cover may also include a flip unit having a frame attached to the telephone body and a flip type cover hingedly connected to the frame for exposing the button portion by means of a pivoting operation thereof. Alternatively, the interchangeable button cover may include a sliding unit having a frame detachably attached to the telephone body and a sliding lid type cover connected to the frame in a manner that allows the sliding lid type cover to slide for exposing the button portion of the mobile telephone.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view showing of a conventional bar-type mobile telephone.

FIG. 2 is a perspective view showing a conventional flip-type mobile telephone.

FIG. 3 is a perspective view showing a conventional sliding lid-type mobile telephone.

FIG. 4 is a perspective view showing the telephone body of a mobile telephone according to a preferred embodiment of the invention.

FIGS. 5(a), (b) and (c) are perspective views showing respective covers for including on the mobile telephone according to a preferred embodiment of the invention.

FIGS. 6(a), (b) and (c) are perspective views showing assembled examples of the telephone body and the respective covers of the mobile telephone according to a preferred embodiment of the invention.

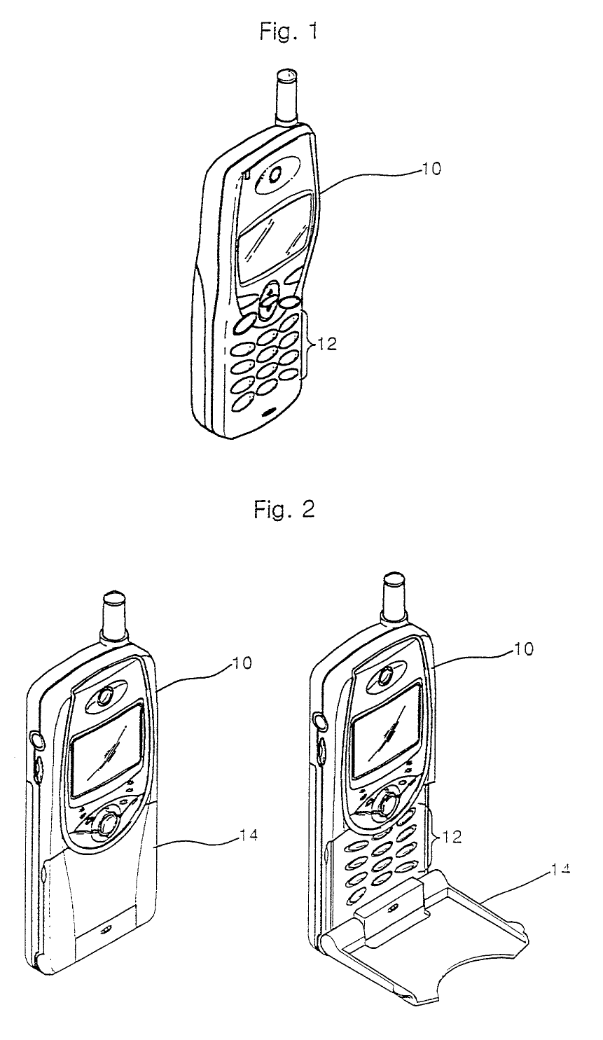

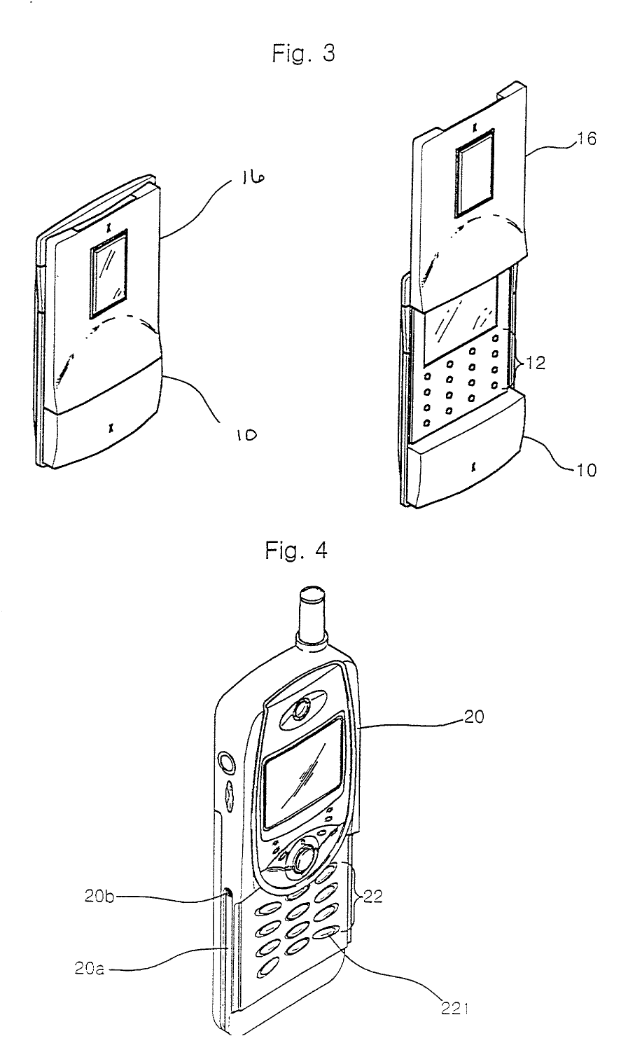

### DETAILED DESCRIPTION OF PREFERRED EMBODIMENTS

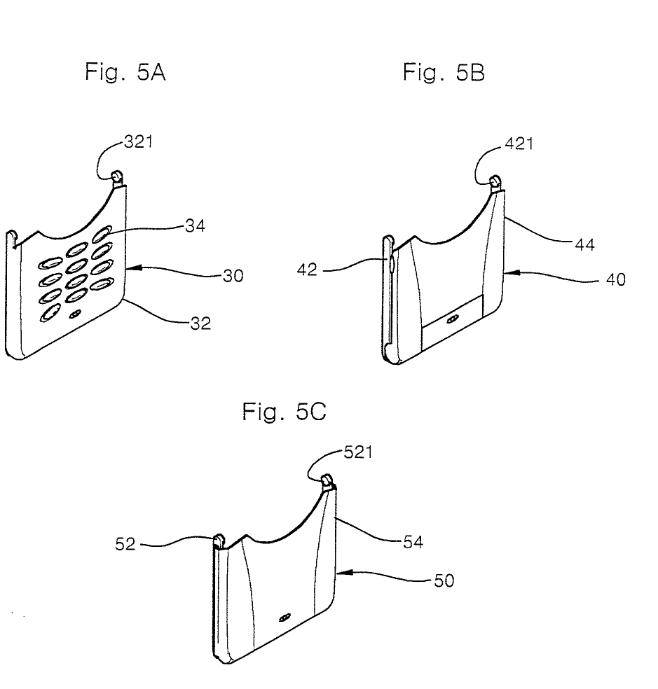

A mobile telephone according to a preferred embodiment of the invention is shown in FIG. 4 and includes a telephone body 20 provided with a button portion 22, and interchangeable button covers detachably coupled to the telephone body 20. The interchangeable button covers are structures for protecting and/or exposing the button portion 22 of the telephone body 20. The interchangeable button covers are interchangeable structures which can be attached to and removed from the mobile telephone and includes a bar type cover, a flip type cover, and a sliding lid type cover. The interchangeable button cover may include a bar unit 30 as shown in FIG. 5(a) for providing the bar-type cover for a mobile telephone, a flip unit 40 as shown in FIG. 5(b) for providing the flip-type cover for mobile telephone, or a sliding unit 50 as shown in FIG. 5(c) for providing the sliding lid-type cover for a mobile telephone.

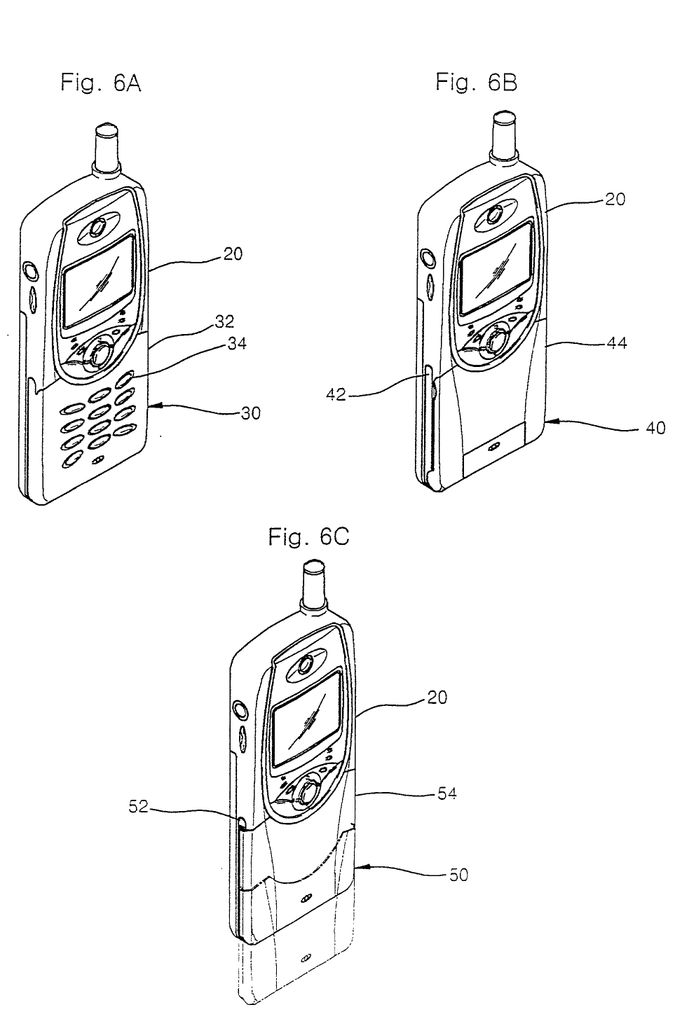

The bar unit 30 of FIGS. 5(a) and 6(a) includes a frame 32 for mounting on the telephone body 20 of FIG. 4. The frame 32 encloses the button portion 22 and the keypads 34 provided on one side of the frame 32 and interlocked with the key buttons 221 of the button portion 22. The keypads 34 are made of an elastic material. A user can press the key buttons 221 of the button portion 22 through the elastic material of the keypads 34 of the bar unit 30.

The flip unit 40 of FIGS. 5(b) and 6(b) includes a frame 42 for mounting on the telephone body 20 of FIG. 4. The flip unit 40 also includes a flip type cover 44 hingedly connected to the frame 42 for exposing the button portion 22 by means of the flip cover 44 pivoting on the frame 42. In use, the user accesses the button portion 22 of the telephone body 20 by pivoting the flip type cover 44 upward to expose the button portion 22.

The sliding unit 50 of FIGS. 5(c) and 6(c) includes a frame 52 for mounting on the telephone body 20. The sliding unit 50 also includes a sliding lid type cover 54 slidably connected to the frame 52 for exposing the button portion 22 by means of a sliding operation thereof. In use, the user accesses the button portion 22 by downwardly sliding the sliding lid type cover 54 to expose the button portion 22.

Each of the frames 32,42,52 of the corresponding units 30,40, 50 of FIGS. 6(a), 6(b) and 6(c), respectively, are kept securely mounted to the telephone body 20 by catching projections 321, 421 and 521 shown in FIGS. 5(a), 5(b) and 5(c), respectively. The catching projections 321, 421, 521 which are formed on both left and right inner side surfaces of the respective frames, are slidably inserted along straight grooves 20a shown in FIG. 4 which are formed on both left and right side surfaces of the telephone body 20. The catching projections 321, 421 and 521 are then fitted into fixing recesses 20b disposed at upper ends of the straight grooves 20a.

The mobile telephone in accordance with a preferred embodiment of the invention includes an interchangeable button cover which allows the manner of protecting and exposing the button portion 22 to be variably changed by alternatively mounting the respective units 30,40, 50 on the telephone body 20. That is, when the bar unit 30 is mounted on the body 20, the key buttons 221 can be operated through the elastic keypads 34 exposed to the user without having to perform any additional step to access the key buttons 221. Alternatively, when the flip unit 40 is mounted on the telephone body 20, the button portions 22 can be exposed or covered by opening or closing the flip type cover 44 by pivoting the flip type cover 44 connected to the telephone body 20 by a hinge. Finally, when the sliding unit 50 is mounted on the telephone body 20, the button portions 22 can be exposed or covered by opening or closing the sliding lid type cover 54 by sliding the sliding lid type cover 54 in the desired direction.

Thus, according to the embodiment of the present invention, a user can easily alter the manner of protecting and exposing the button portion of a the mobile telephone by mounting one of the units 30, 40, 50 on the telephone body 20 according to the user's preference. Furthermore, since the design of the mobile telephone is alterable at the user's will, the user does not easily get bored with his/her mobile telephone.

As described above, according to a preferred embodiment of the invention, the manner of protecting or covering and exposing the button portion of a mobile telephone can be variably changed because the user can alter the mobile telephone into a bar type cover, a flip type cover, or a sliding lid type cover, or the like in accordance with the user's need or taste. By an interchangeable button cover, the user does not easily get bored with the mobile telephone.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A mobile telephone comprising:
a telephone body comprising a button portion; and
an interchangeable button cover that can detachably couple with the body.

2. The mobile telephone of claim 1, wherein the interchangeable button cover comprises a structure for exposing the button portion which can be selectively changed between a bar type cover, a flip type cover or a sliding lid type cover.

3. The mobile telephone of claim 1, wherein the interchangeable button cover comprises a bar unit comprising a frame detachably mounted on the telephone body so as to enclose the button portion and keypads provided on one side of the frame and interlocked with key buttons of the button portion.

4. The mobile telephone of claim 1, wherein the interchangeable button cover comprises a flip unit comprising a frame detachably mounted to the telephone body and a flip cover hingedly connected to the frame for exposing the button portion by means of a pivoting operation.

5. The mobile telephone of claim 1, wherein the interchangeable button cover comprises a sliding unit comprising a frame detachably mounted to the telephone body and a sliding lid connected to the frame configured to allow the sliding lid to slide for exposing the button portion.

6. An interchangeable button cover for a mobile telephone body, comprising:
a cover configured to cover a plurality of buttons on a mobile telephone body; and
an attachment device disposed on said cover configured to removably attach said cover to a mobile telephone body.

7. The interchangeable cover of claim 6, wherein said cover comprises:
a frame configured for mounting on a mobile telephone body; and
a plurality of keypads disposed on one side of said frame, wherein each keypad of said plurality of keypads communicates with a respective key button of a mobile telephone body.

8. The interchangeable cover of claim 6, wherein said plurality of keypads comprise elastic material.

9. The interchangeable cover of claim 6, wherein said cover comprises:
a frame configured for mounting on a mobile telephone body; and
a flip type member hingedly connected to said frame, wherein said flip type member is configured to pivot on said hinged connection to cover or expose a plurality of key buttons of a mobile telephone body.

10. The interchangeable cover of claim 6, wherein said cover comprises:
a frame configured for mounting on a mobile telephone body; and
a sliding member slidingly attached to said frame, wherein said sliding member is configured to slide on said frame to cover or expose a plurality of key buttons of a mobile telephone body.

11. The interchangeable cover of claim 6, wherein said attachment device comprises a plurality of projections configured to mate with a corresponding plurality of grooves provided on a mobile telephone body.

12. A mobile telephone, comprising:
a telephone body;
a plurality of grooves disposed in said telephone body;
an interchangeable cover configured to cover a plurality of buttons on said telephone body; and
an attachment device disposed on said cover configured to removably engage said plurality of said grooves.

13. The mobile telephone of claim 12, wherein said interchangeable cover further comprises:
a frame configured for mounting on said telephone body; and
a plurality of keypads disposed on one side of said frame, wherein each keypad of said plurality of keypads communicates with a respective key button of said telephone body.

14. The mobile telephone of claim 12, wherein said interchangeable cover further comprises:
a frame configured for mounting on said telephone body; and
a flip type member hingedly connected to said frame, wherein said flip type member can pivot on said hinged connection to cover or expose a plurality of key buttons of said telephone body.

15. The mobile telephone of claim 12, wherein said interchangeable cover further comprises:
a frame configured for mounting on said telephone body; and
a sliding member slidingly attached to said frame, wherein said sliding member is configured to slide on said frame to cover or expose a plurality of key buttons of said telephone body.

16. The interchangeable cover of claim 12, wherein said plurality of grooves are substantially straight.

17. The interchangeable cover of claim 12, wherein said plurality of grooves comprise fixing recesses, and said attachment device comprise catching projections configured to removably engage said fixing recesses.
